(19) United States
(12) Patent Application Publication
(10) Pub. No.: US 2017/0055670 A1
(43) Pub. Date: Mar. 2, 2017

(54) HAIR DRYER WITH WIRELESS SPEAKERS

(71) Applicant: Winifred Rachelle Carrier, Loganville, GA (US)

(72) Inventor: Winifred Rachelle Carrier, Loganville, GA (US)

(21) Appl. No.: 15/250,880

(22) Filed: Aug. 29, 2016

Related U.S. Application Data
(60) Provisional application No. 62/211,451, filed on Aug. 28, 2015.

(51) Int. Cl. A45D 20/42; H04R 1/02

(52) U.S. Cl. CPC A45D 20/42; H04R 1/028; H04R 1/026; H04R 2420/07

(57) ABSTRACT

Implementations of a hair dryer with wireless speakers are provided. In some implementations, the hair dryer comprises an external hood, an internal hood wherein at least a portion of the internal hood is positioned inside the external hood thereby forming a gap between the external hood and the internal hood. In some implementations, the hair dryer includes one or more wireless speakers; and a wireless receiver operatively connected to the one or more speakers and configured to receive content wirelessly and transmit to the wireless speaker.

### CROSS REFERENCE TO RELATED APPLICATION

This application claims the benefit of U.S. Patent Application Ser. No. 62/211,451, which was filed on Aug. 28, 2015, and is incorporated herein by reference in its entirety.

### TECHNICAL FIELD

This disclosure relates to implementations of a hair dryer with wireless speakers.

### BACKGROUND

A user sitting under a hair dryer to dry the user's hair can be a time consuming and/or unstimulating process in that the user may not be able to perform activities that the user may normally perform due to noise, such as talking on a mobile phone, listening to music, or watching television. U.S. Pat. Nos. 5,647,007 and 5,531,032 disclose a hair dryer stereo system. However, the hair dryer disclosed in the '007 patent and the '032 patent is complicated and costly to make.

### BRIEF DESCRIPTION OF THE DRAWINGS

FIG. 1 illustrates an implementation of an example hair dryer with wireless speakers according to the present disclosure.

### DETAILED DESCRIPTION

Implementations of a hair dryer with speakers wirelessly connected to a content source (e.g., a user's cell phone) are provided. In this way, a user under a hair dryer can hear audio from the content source while the hair dryer is operational. For example, a user may be able to listen to audio (e.g., music, voice) from a cell phone, television, or radio (e.g., a radio in a salon in which the hair dryer is located). Implementations of a hair dryer with wireless speakers are provided. In some implementations, the hair dryer comprises an external hood, an internal hood wherein at least a portion of the internal hood is positioned inside the external hood thereby forming a gap between the external hood and the internal hood. In some implementations, the hair dryer includes one or more wireless speakers and a wireless receiver operatively connected to the one or more speakers and configured to receive content wirelessly and wirelessly transmit to the wireless speaker.

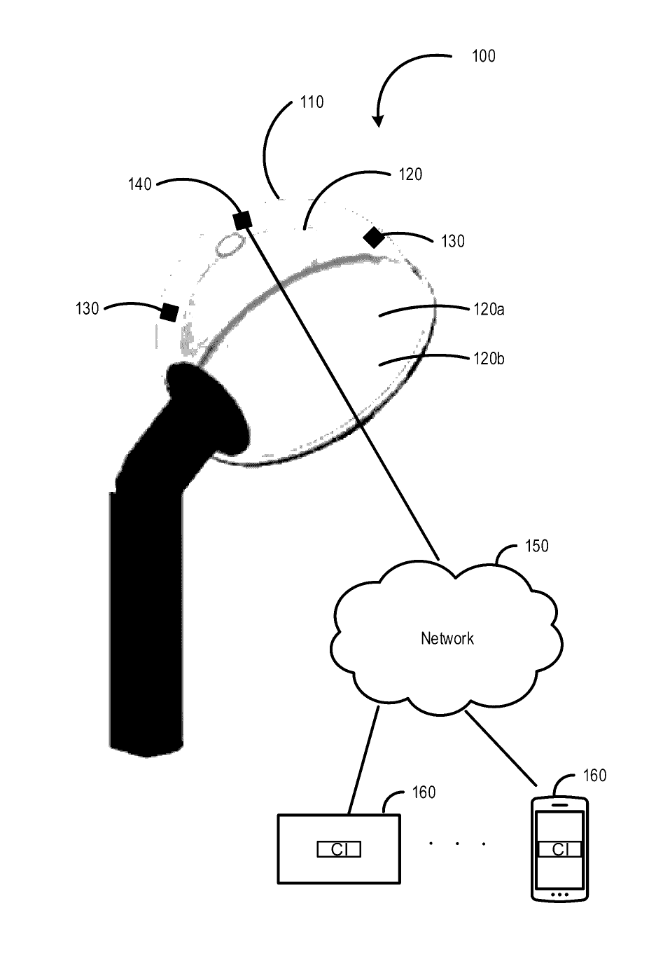

FIG. 1 illustrates an implementation of an example hair dryer 100 according to the present disclosure.

In some implementations, the hair dry 100 may be a hooded/bonnet hair dryer. In some implementations, the hair dryer may be a hard hat or hard bonnet hair dryer. In some implementations, the hair dryer may be a soft bonnet hair dry. In some implementations, the hair dryer may be any device configured to blow air into a hood placed about a seated person's head to dry the person's hair. In some implementations, the hair dryer surrounds a portion of the user's head.

In some implementations, the hair dryer 100 may comprise an external hood 110, a smaller, internal hood 120, one or more speakers 130, and a wireless receiver 140.

In some implementations, the external hood 110 comprises a surface that is convex in shape forming a first open enclosure. The external hood 110 may have a first diameter.

In some implementations, the internal hood 120 comprises a surface that is convex in shape forming a second open enclosure. In some implementations, the internal hood 120 may have second diameter that is smaller than the first diameter.

In some implementations, at least a portion of the internal hood 120 is positioned inside the external hood 100 forming a gap between the external hood 110 and the internal hood 120.

In some implementations, internal hood 120 is positioned completely inside the external hood where a gap exists between the external hood 110 and the internal hood 120.

In some implementations, the internal hood 120 may include a plurality of openings 120b through the surface of the internal hood. In a traditional dryer, air is directed through these holes.

In some implementations, the one or more speakers 130 may be located between the external hood 110 and the internal hood 120 where the gap is formed. In this way, sound can be directed through the openings 120b.

In some implementations, the one or more speakers 130 may be connected to the inner surface 120a of the internal hood 120 where the outer surface of the speaker extend within the second open enclosure of the internal hood 120.

In some implementations, the one or more speakers 130 may be connected to the outer surface of the external hood 110, which may have an opening therethrough for sound to be directed inside the eternal hood 110. In some implementations, the opening may extend through the internal hood 120.

In some implementations, the hair dryer 100 may include two speakers located on opposite sides of the hair dryer 100. In some implementations, the one or more speakers are located at any suitable location.

In some implementations, the one or more speakers 130 are wireless.

In some implementations, the wireless receiver 140 may be configured to receive content wirelessly communicated over a wireless network 150 from one or more content sources 160 configured to transmit content wirelessly. In some implementations, a content source 160 may be a TV, radio, or portable or mobile electronic device, or any other content source. In some implementations, a portable or mobile electronic device may be a smartphone, a cell phone, personal digital assistant (PDA), laptop computer, tablet-style computer, or any other device that a user may hold in his or her hand.

In some implementations, the wireless receiver 140 may be located between the external hood 110 and the internal hood 120. In some implementations, the wireless receiver 140 may be connected to the inner surface 120a of the internal hood 120. In some implementations, the wireless receiver 140 may be located near the top of the hair dryer. In some implementations, the wireless receiver 140 may be attached to the outer surface of the external hood 110. In some implementations, the wireless receiver 140 may be located at any suitable location.

In some implementations, the wireless receiver 140 and speakers 130 may be connected such that if the hair dryer is connected to a power source, the wireless receiver 140 and speakers 130 also receive power.

In some implementations, the wireless receiver 140 is operably connected to the speakers to transmit audio received from the one or more content sources 160 to the one or more speakers 130. In some implementations, the wireless receiver 140 may be integrated into one or more of the speakers 130.

In some implementations, the hair dryer may have a face shield (e.g., a portion that extends down from a rim of the hair dryer 100. In this way, the face shield may help to direct and/or amplify the sounds from the one or more speakers.

In some implementation, the wireless receiver 140 and/or one or more speaker 130 may include flexible circuitry mounted on either the internal or external surface of the internal hood 120 or the internal surface of the external hood 110. In some implementations, the one or more speakers 130 can be thin and bendable (e.g., FleXpeaker™ by Industrial Technology Research Institute).

In some implementations, the one or more speakers may be integral to the hair dryer. In some implementations, the one or more speakers may be detachable and portable. In some implementations, the one or more speakers may be attached using magnets. In some implementations, the one or more speakers may be configured to attach to one or more openings 120b in the internal hood 120. For example, a portion of a speaker or one or more connector attached to the speaker may be configured to be inserted into one or more openings 120b in the internal hold 120.

In some implementations, plugs may be provided to block one or more openings 120b that the speakers may cover when installed. In this way, when the hair dryer is on, air will not come through the openings where the speakers are installed.

In some implementations, each content source 160 may be an electronic device including hardware, software, or embedded logic components or a combination of two or more such components and capable of carrying out the appropriate functions implemented or supported by the content source 160.

In some implementations, the wireless network 150 can include a WI-FI network, a wireless cellular network, a Wi-Max network, a long-range wireless data network, an ad hoc network, a personal area network (PAN) (such as BLUETOOTH), a local area network (LAN), a wide area network (WAN), a metropolitan area network (MAN), one or more portions of the Internet, or a combination of two or more of these networks.

In some implementations, each of the wireless receiver 140 and one or more content sources 160 may include a communication interface (CI). In some implementations, the communication interface may include hardware, software, or both providing one or more interfaces for communication between wireless receiver 140 and one or more content sources 160 or one or more wireless networks. As an example and not by way of limitation, the communication interface may include a wireless network interface controller (WNIC) or wireless adapter for communicating with a wireless network, such as a WI-FI network.

This disclosure contemplates any suitable network and any suitable communication interface for it. As an example and not by way of limitation, the wireless receiver 140 and one or more content sources 160 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless.

As an example, the wireless receiver 140 and one or more content sources 160 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

The wireless receiver 140 and one or more content sources 160 may include any suitable communication interface for any of these networks, where appropriate. The communication interface may include one or more communication interfaces, where appropriate. Although this disclosure describes and illustrates a particular communication interface, this disclosure contemplates any suitable communication interface.

Reference throughout this specification to “an embodiment” or “implementation” or words of similar import means that a particular described feature, structure, or characteristic is included in at least one embodiment of the present invention. Thus, the phrase “in an embodiment”, “in some implementations”, or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An apparatus comprising:
an external hood wherein the external hood comprises a surface that is convex thereby forming a first open enclosure and wherein the external hood has a first diameter;
an internal hood wherein the internal hood comprises a surface that is convex thereby forming a second open enclosure and wherein the internal hood has a second diameter that is smaller than the first diameter, wherein at least a portion of the internal hood is positioned inside the external hood thereby forming a gap between the external hood and the internal hood, wherein the internal hood includes a plurality of openings through the surface of the internal hood configured for air flow;
one or more wireless speakers; and
a wireless receiver operatively connected to the one or more speakers and configured to receive content wirelessly and transmit content wirelessly to the one or more wireless speakers.

2. The apparatus of claim 1 wherein the one or more speakers are located between the external hood and the internal hood where the gap is formed and positioned over a plurality of the openings in the internal hood configured for air flow.

3. The apparatus of claim 1 wherein the one or more speakers are detachable from the apparatus.

4. The apparatus of claim 3 wherein the one or more speakers may be connected to the inner surface of the internal hood where the outer surface of the one or more speakers extend within the second open enclosure of the internal hood.

5. The apparatus of claim 4 wherein the one or more speakers are be configured to attach to one or more of the openings in the internal hood configured for air flow.

6. The apparatus of claim 5 wherein a portion of the one or more speakers is configured to be inserted into one or more of the openings in the internal hood configured for air flow.

7. The apparatus of claim 4, the apparatus further comprising a plurality of plugs inserted into one or more of the openings in the internal hood configured for air flow where the speaker is installed.

8. The apparatus of claim 1 wherein the one or more speakers are attached using magnets.

9. An apparatus comprising:
an external hood wherein the external hood comprises a surface that is convex thereby forming a first open enclosure and wherein the external hood has a first diameter;
an internal hood wherein the internal hood comprises a surface that is convex thereby forming a second open enclosure and wherein the internal hood has a second diameter that is smaller than the first diameter, wherein at least a portion of the internal hood is positioned inside the external hood thereby forming a gap between the external hood and the internal hood, wherein the internal hood includes a plurality of openings through the surface of the internal hood configured for air flow;
one or more speakers wherein each of the one or more speakers comprises an a array of bendable smaller speakers to create a planar speaker that is bendable; and
a wireless receiver operatively connected to the one or more speakers and configured to receive content wirelessly and transmit content wirelessly to the one or more wireless speakers.

10. The apparatus of claim 9 wherein the one or more speakers are located between the external hood and the internal hood where the gap is formed and positioned over a plurality of the openings in the internal hood configured for air flow.
